(19) United States
(12) Patent Application Publication
(10) Pub. No.: US 2003/0029972 A1
(43) Pub. Date: Feb. 13, 2003

(54) Stabilizer for objects such as cables and wires

(76) Inventor: J. Linn Rodgers, Elyria, OH (US)

Correspondence Address: DONALD D. MON, ATTORNEY AT LAW, SUITE 303, 750 EAST GREEN STREET, PASADENA, CA, 91101, US

(21) Appl. No.: 09/925,290

(22) Filed: Aug. 8, 2001

(51) Int. Cl. F16L 3/00

(52) U.S. Cl. 248/49; 248/68.1

(57) ABSTRACT

A stabilizer to hold two objects in position. It includes a pair of hook-like retainers joined together by a flexible stiffly springy joinder. A stub extending from one of the retainers carries a cross-bar that can be pulled by two fingers to pull one retainer over an object, and can be stretched to fit the other retainer over the other object, the joinder tending to return to a rest position to stabilize the assembled objects and stabilizer.

### FIELD OF THE INVENTION

A stabilizer to hold cables and wires in position.

### BACKGROUND OF THE INVENTION

Electrical and electronic equipment include cables and bundles of wire which must be stabilized in the structure. It is common practice for many of these to be held by twisted ties. These ties are slow to create, and involve repetitive motions of the hand and wrist which are at best uncomfortable, and at worst are potentially harmful to the installer.

These are actually time-limiting factors in the production of many kinds of electronic apparatus. It is not uncommon for some stabilizer arrangements of this type to require time on the order of several minutes or more for each individual stabilization. Due to access limitations, simply adding more people is only a partial remedy. Instead it simply takes more time on the production line. The cost of this delaying lag time in the production line and the discomfort and disabilities involved have long called for improvement, and yet at this time, the existing practices are continuing for want of a better way.

This invention provides a device which can, in only a few seconds, engage and stabilize a pair of wires or cables that otherwise can take minutes, and this with no threat to the installer.

It is a object of this invention to provide a stabilizer able to grasp and hold a plurality of wires, cables or anchors. It enables an installer to do this merely by pulling on one end of the device so as to trap both items, and then restore itself to its memory position.

### BRIEF DESCRIPTION OF THE INVENTION

A stabilizer according to this invention includes a pair of hook-like retainers joined by a stiffly springy joinder. A pull bar is joined to one of the retainers. When the pull bar is pulled, the remote hook can readily be placed over whatever it is to engage. Then with an additional pull that further elongates the joinder, the pull bar can be manipulated to place the other retainer on to the other item to be engaged. Releasing the pull bar engages both retainers while it returns toward its relaxed condition, and establishes the spacing between the gripped items.

According to a preferred embodiment of the invention, the stabilizer is a single piece unitary and continuous structure molded from a thermoplastic resin.

The above and other features of this invention will be fully understood from the following detailed description and the accompanying drawings, in which:

### BRIEF DESCRIPTION OF THE DRAWINGS

FIG. 1 is a plan view of the presently-preferred embodiment of the invention;

FIG. 2 is side view taken at line 2-2 in FIG. 1; and

FIG. 3 is a plan view of a device such as FIGS. 1, modified to accommodate a different spacing.

### DETAILED DESCRIPTION OF THE INVENTION

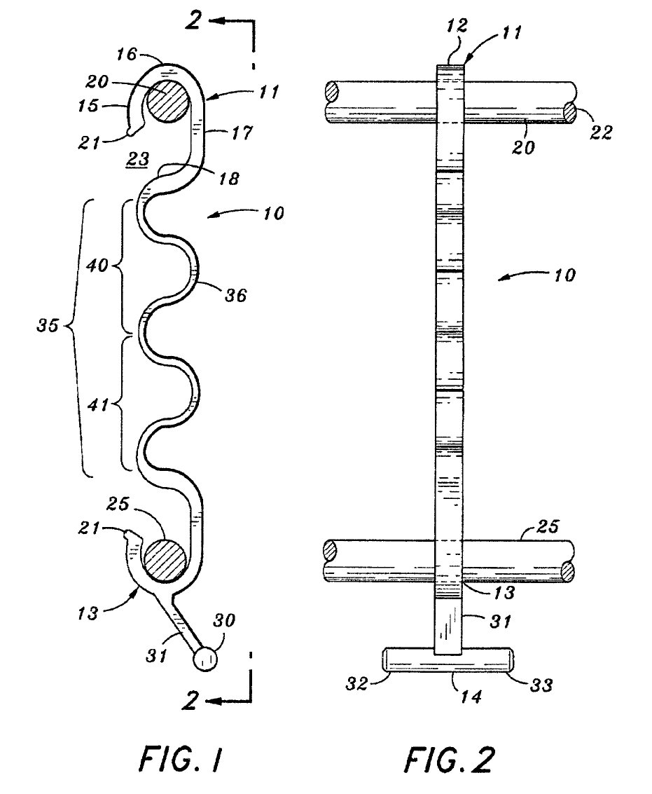

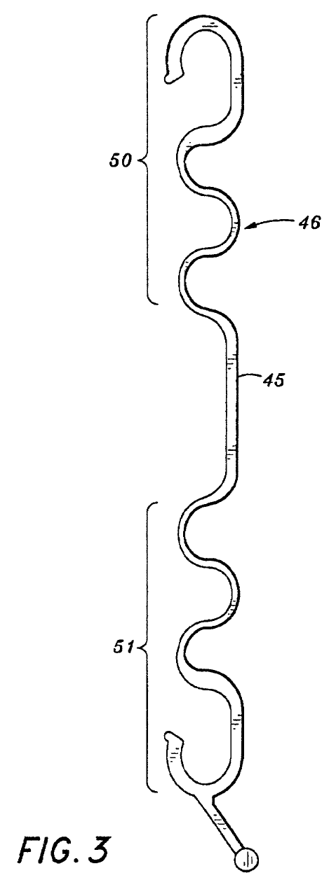

The presently-preferred embodiment of a stabilizer 10 according this invention is shown in FIGS. 1 and 2. A first retainer 11 is provided at a first end 12 of the device, and a second retainer 13 is provided at its second end 14.

The retainers are conveniently made identically, although each could be made a different shape or size to accommodate a different installation. In every embodiment, each retainer is hook-like, with an overhanging segment 15, a bight segment 16, a back segment 17, and a base segment 18.

The overhanging segment is intended to project from the bight segment sufficiently to retain an object 20. When the object is circular, such as a cable or a bundle of wires, the end 21 of the overhanging segment will be across the center line 22 of the object. This arrangement can conveniently be regarded a shielding more than 180 degrees of the object. This serves to retain an object so it cannot slide out laterally.

Spacing 23 between end 21 and base segment 18, when the stabilizers are relaxed, is preferably but not necessarily smaller than the diameter of the object. This provides an additional retention feature.

Second retainer 13 is formed (although not necessarily identically formed) identically to first retainers 11. It bears the same reference numbers. Its purpose is to engage a second object 25, which may be the same kind as object 20, although it may be different.

A pull rod 30 is joined to one of the retainers by a stub 31. The pull rod preferably has segments 32,33 extending on opposite sides of the stub so it can be gripped and pulled by two fingers to install the stabilizer.

A joinder 35 joins the two retainers to one another at their base segments. The joinder is stiffly springy and flexible. It is preferably sinuous, having a plurality of wave-like undulations 36. While the retainers could be made of a different material than the joinder it is best practice and also least expensive to mold the entire stabilizer in a single piece.

For this reason the retainers will preferable have a substantial cross-section so they will be stiffer. The joinder will have a lesser cross-section so it can provide a springier action. This relationship enables the retainers to be strongly attached to the objects, but be spread apart be a pull on the pull rod to facilitate their attachment, and the joinder can act as a stiff spring.

The preferred cross-section of the stabilizer is square or rectangular, for convenience in molding. It may instead be circular or any other desired shape. It should be noted that the object of this invention is for an installer, using only one hand, to hold the stabilizer and hook the first retainer over an object, readily rotating the stabilizer to align it, this without regarding the use of his other hand. A substantial cross-section enables this.

The undulations act as a stiff spring which can be elongated to enable the installation, and will return toward its release configuration when the pull tool is released. Generally, at least two full sine-wave undulations (40 and 41 in FIG. 1) will be provided for best performance. While more of them can be provided, they may result in more flexibility and less resistance to stretch than desired.

Therefore, in order to make a longer stabilizer, it is best practice to insert a spacer segment 45 in stabilizer 46, shown in FIG. 4. This is simply a rigid straight segment which will not elongate, so the function of stabilizer 4b is essentially the same as stabilizer 10 in FIG. 1. Its use is identical to that of stabilizer 10. As a convenience in manufacture it will be noted that the two end segments 50,51 are the two halves of stabilizer 10. An insert can be placed between them so that the costly parts of an injector mold can be used to produce stabilizers of different length.

Different materials of construction may be used, but the best selections will be made from a wide selection of thermoplastic resins and mixtures of thermoplastic resins. These are selected for moldability and the stiff flexibility required for the task. The presently preferred resin is Nylex, a mixture of nylon and polypropylene. Other suitable resins are celcon and delrin.

This invention is not to be limited by the embodiments shown in the drawings and described in the description, which are given by way of example and not of limitation, but only in accordance with the scope of the appended claims.

I claim:

1. A Unitary stabilizer for holding a pair of objects and retaining them at an established spacing apart, said stabilizer comprising:
a first and a second hook-like retainer, each said retainer having an overhanging segment, a bight segment, a back segment and a base segment, whereby to form an opening to receive a respective object, each overhanging segment having an end spaced from its respective base segment as to permit entry of the object;
a joinder joining to said two base segments, said joinder including a plurality of undulations to permit extension of said hook-like retainers from one another; and
a pull rod extending from said second retainer, said pull rod including a stub and laterally extending segments, whereby, by engagement of said pull rod with two fingers, and with said first retainer engaged to an object, the stabilizer can be elongated to enable a second object to be placed in said second retainer.

2. A stabilizer according to claim 1 in which said stabilizer is formed as a single unitary piece from a thermoplastic resin, said resin which cured having the property of stuff, springy resilience.

3. A stabilizer according to claim 1 in which said retainers are stiffly flexible to enable bending of the segments to admit an object.

4. A stabilizer according to claim 2 in which said undulations form at least two full sine wave cycles.

5. A stabilizer according to claim 1 in which a rigid spacer is formed between two undulations to vary the spacing between the retainers.

6. A stabilizer according to claim 1 in which the cross-section of the retainers is larger that the cross-section of the joinder.

7. A stabilizer according to claim 6 in which said cross-sections are rectangular.
